(19) United States
(12) Patent Application Publication
(10) Pub. No.: US 2010/0064559 A1
(43) Pub. Date: Mar. 18, 2010

(54) ELEMENT FOR SIGNS, PROCESS FOR MANUFACTURING IT, SYSTEM AND SIGN OBTAINED THEREWITH

(76) Inventor: Pierino Dal Cavaliere, Brendola (IT)

Correspondence Address: BIRCH STEWART KOLASCH & BIRCH, PO BOX 747, FALLS CHURCH, VA, 22040-0747, US

(21) Appl. No.: 12/513,475

(22) PCT Filed: Nov. 7, 2007
(86) PCT No.: PCT/IB07/03446

§ 371 Date: May 4, 2009

(30) Foreign Application Priority Data
Nov. 9, 2006 (IT) VI2006A000325

(51) Int. Cl. G09F 13/00; G09F 7/00; B23C 3/00

(52) U.S. Cl. 40/545; 40/584; 40/541; 40/564; 409/131

(57) ABSTRACT

The invention concerns an element for signs (1, 100, 101, 102) comprising a main body (2, 2a, 2b, 20a, 21c). The main body (2, 2a, 2b, 20a, 21c) is made with a polymer. The invention also concerns a process and a system for-manufacturing the element for signs.

The invention concerns an element to be used for making signs, in particular luminous signs, as well as a process for manufacturing said element with a corresponding manufacturing system and the sign obtained therewith.

As already known, for making up some types of signs, in particular with company names and trade names, luminous elements with reflected light are used, which reproduce characters such as, for example, letters, numbers, symbols and the like.

These elements for signs of the type with reflected light comprise a hollow box-shaped body made of a metallic material and open on the side opposite the exposed face, said exposed face having the shape of the character that the element is intended to reproduce.

Inside this box-shaped body there are the lighting equipment and the lights, typically constituted by fluorescent tubes, preferably neon tubes, whose light is emitted from the back of the sign element, thus creating a suggestive and diffuse halo effect on the wall to which the element is applied.

The box-shaped body mentioned above is constructed with substantially manual operations.

In particular, the side surface of said body is obtained in more than one step, working and properly bending with bare hands one or more metal sheets in order to shape them as desired, and then securing said sheets to the exposed face of the body at the level of the edge of said face by welding and tinning, after cleaning of the pieces to be joined with tin and sulphuric acid.

A first drawback posed by this type of process lies in that the above mentioned operations are dangerous for the personnel who carry them out, are potentially toxic due to the exhalation of noxious fumes and may cause fires.

A further drawback lies in that the working conditions of the operators are difficult because of these fumes and the dazzling effect deriving from welding and the high temperatures, and become almost unbearable during the hot season.

A further drawback is constituted by the fact that specialised and experienced personnel as well as specific equipment are needed to carry out this type of operations.

A further drawback connected to the previous one is constituted by the fact that execution times and costs are considerable and sometimes difficult to quantify.

A further drawback lies in that the procedures mentioned above do not allow high quality products with repetitive characteristics and homogeneous delivery times to be obtained.

Another drawback lies in that the materials used for making the bodies of the sign elements, like copper, brass, steel, aluminium, galvanized plate are very expensive and subject to the fluctuations of international markets.

Another drawback is represented by the fact that these bodies are subject to deterioration, especially in the points where the metal sheets are bent and welded, in particular as a consequence of oxidation and sulphation due to the conditions of the environment where they are installed.

Another drawback is constituted by the fact the lighting of the sign elements is obtained by means of fluorescent tubes, preferably neon tubes, whose energy consumption is high and whose performance levels rapidly worsen over time, thus requiring routine maintenance.

A further drawback lies in that these elements are rather heavy and fragile, so much that they are difficult to transport and install, which often causes failures and breakages.

The object of the present invention is to overcome the drawbacks described above.

In particular, it is one object of the invention to propose an element to be used for making signs, in particular luminous signs, as well as a process for manufacturing said element with a corresponding manufacturing system and the sign obtained therewith, in order to overcome the drawbacks described above.

It is another object of the invention to propose an element for signs that can be manufactured also automatically, with no need for the intervention of a specialized operator, at the same time guaranteeing the quality and aesthetical characteristics of an handmade product of known type.

It is a further object of the invention to develop a method for making an element for signs and/or a sign that makes it possible to obtain elements and signs having the same characteristics usually obtained with the known manual techniques, with no need for the intervention of a specialized worker.

It is another object of the invention to propose a high-quality element in terms of both functionality and appearance, which remains efficient and attractive over time, independently of the environment where it is installed.

It is another object of the invention to carry out an element for signs that, though having the same characteristics, is lighter than the elements created with the known techniques.

It is another object of the invention to implement a process and a corresponding system that drastically reduce the production time of the element for signs, minimizing and even eliminating the need for specialized labour and thus minimizing production costs.

It is a further aim of the invention to implement a process and a system that ensure standardized production of the element in terms of quality, delivery times, production capacity and production costs.

It is a further aim of the invention to implement a process and a system that eliminate pollution and the use of dangerous materials.

It is another, yet not the least object of the invention, to carry out an element for signs and a sign having any shape and degree of complexity, economic, easy to construct and to assemble, easy to install, suited also for mass production, and a system for the manufacture of such an element and a corresponding sign.

The objects mentioned above are achieved through the design of an element to be used for making signs, and the implementation of a process for manufacturing said element, through the relative sign and a system implementing said method, expressed and characterized in the respective independent claims.

Advantageous embodiments of the invention are the subject of the dependent claims.

The proposed solution advantageously makes it possible to manufacture elements for signs whose body has a repetitive shape, with homogeneous size and production quality and capable of being reproduced over time.

Still advantageously, the proposed solution makes it possible to carry out an element for signs resorting to generic labour widely available on the market. Still advantageously, the solution proposed makes it possible to carry out an element that is lighter than the elements for signs of known type having the same dimensional characteristics.

Still advantageously, the proposed solution makes it possible to carry out an element that can be installed more easily and rapidly while ensuring a higher degree of safety for the operators in charge with installation.

Still advantageously, the proposed solution makes it possible to obtain an element whose body can be directly spray-painted with any type of paint, avoiding application of primers, with consequent time savings and reduced painting times.

Still advantageously, the solution proposed makes it possible to carry out an element that offers higher light yield and efficiency.

The aims and advantages described above will be highlighted in greater detail in the description of some preferred embodiments of the invention, provided indicatively as examples without limitation, with reference to the enclosed drawings, wherein:

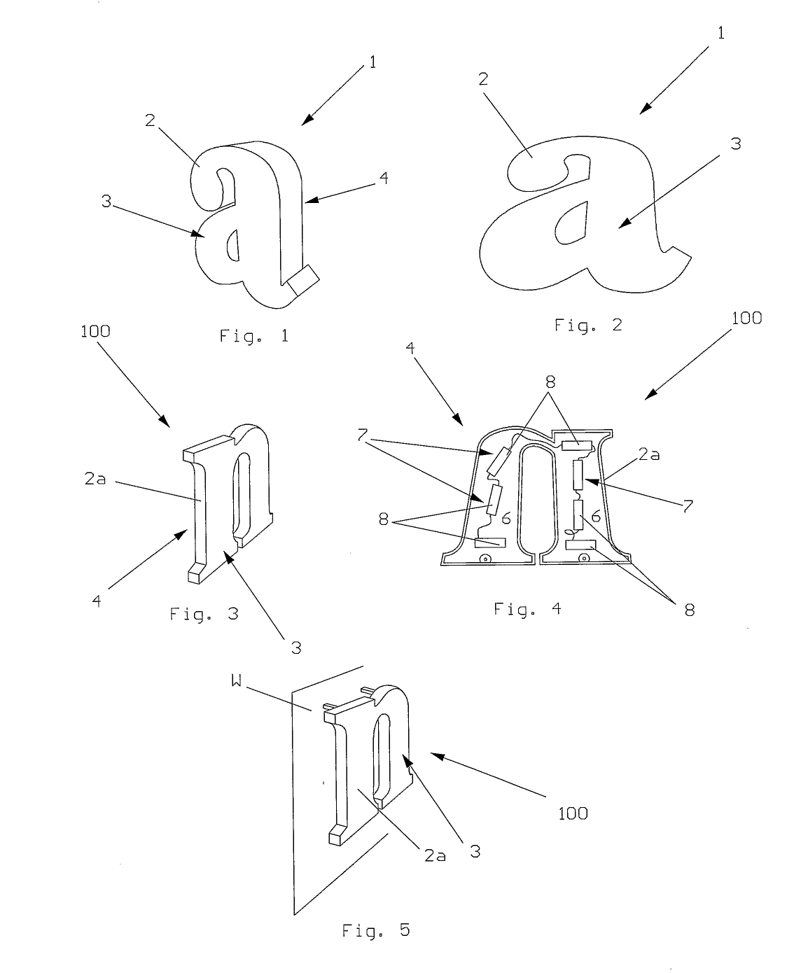

FIG. 1 shows a perspective view of an example of embodiment of an element for signs carried out according to the invention;

FIG. 2 is a front view of the element shown in FIG. 1;

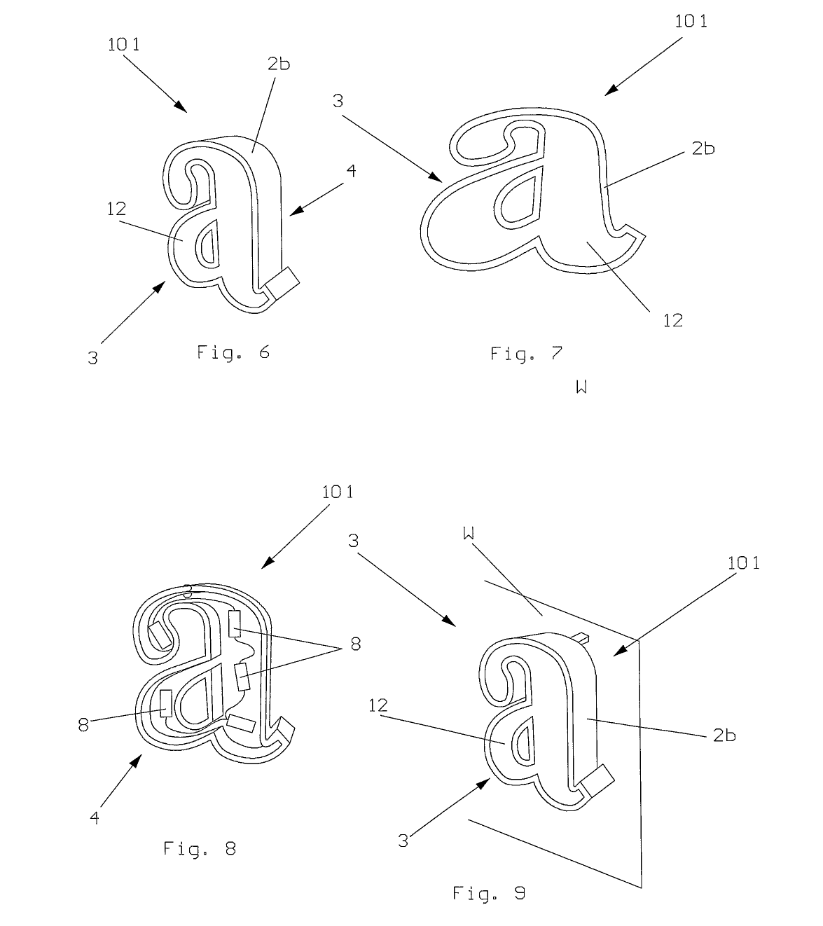

FIG. 3 shows a perspective view of another example of embodiment of an element for signs carried out according to the invention;

FIG. 4 is a rear view of the element shown in FIG. 3;

FIG. 5 is a perspective view of the element shown in FIG. 3 fixed to a wall;

FIG. 6 shows a perspective view of a further example of embodiment of an element for signs carried out according to the invention;

FIG. 7 is a front view of the element shown in FIG. 6;

FIG. 8 is a rear view of the element shown in FIG. 6;

FIG. 9 is a perspective view of the element shown in FIG. 6 fixed to a wall;

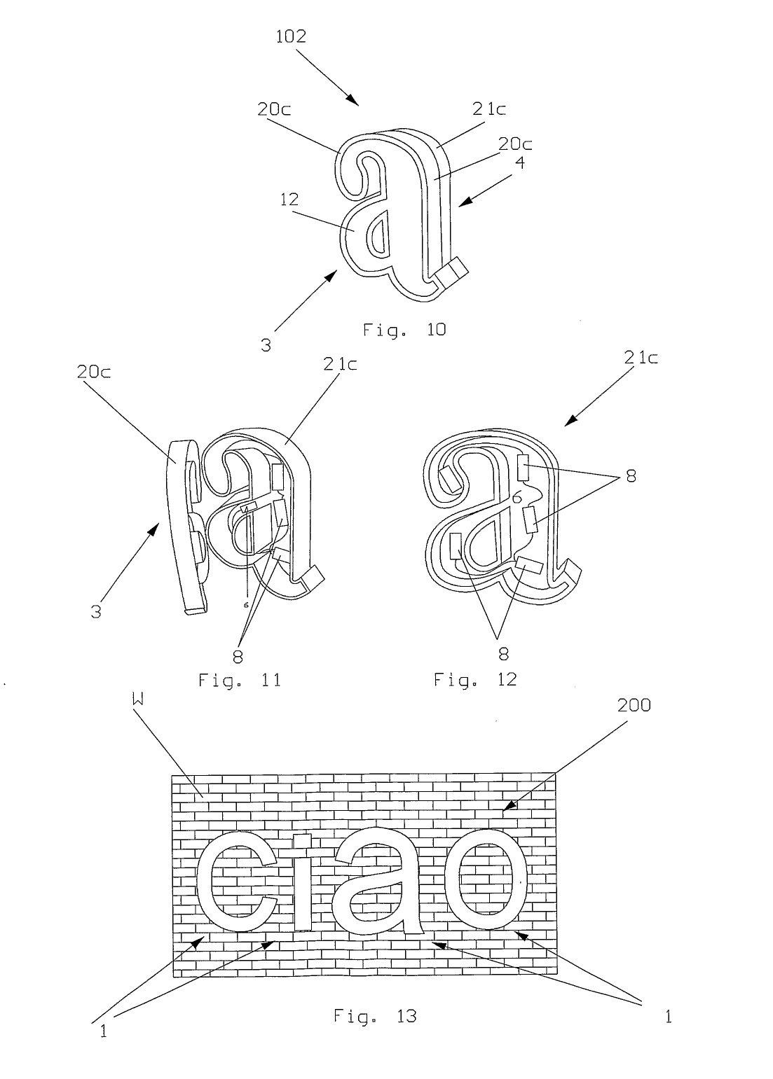

FIG. 10 shows a perspective view of another example of embodiment of an element for signs carried out according to the invention;

FIG. 11 is another perspective view of the element shown in FIG. 10 when open;

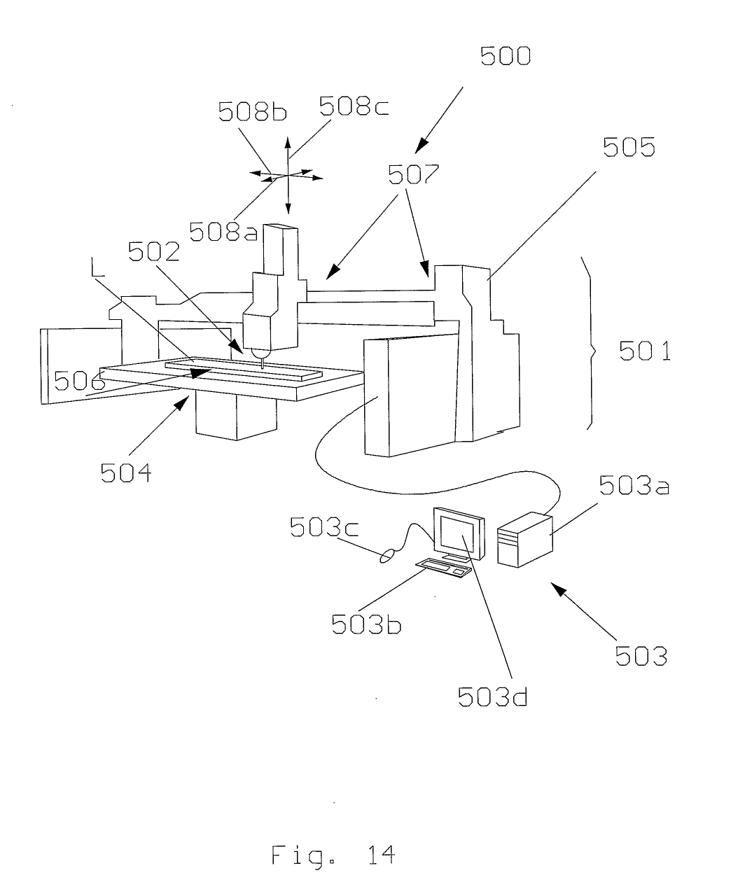

FIG. 12 is a view of a part of the element shown in FIG. 10;

FIG. 13 shows a front view of an example of embodiment of a sign carried out according to the invention;

FIG. 14 shows a schematic perspective view of a system for making an element for signs and/or a sign, which is also the subject of the invention;

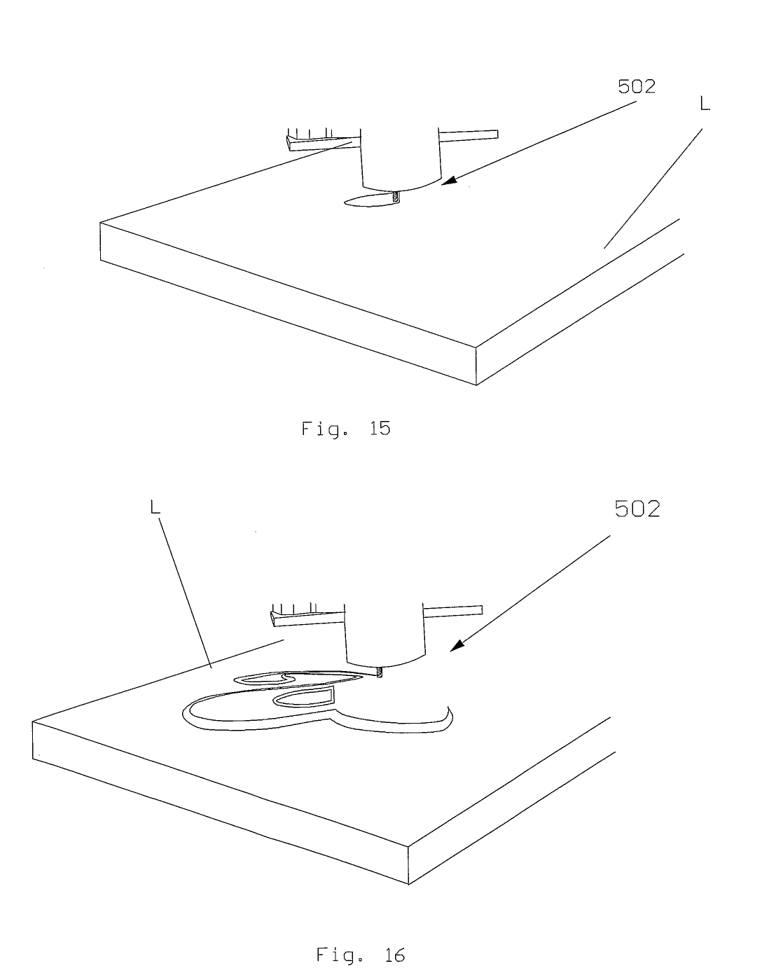

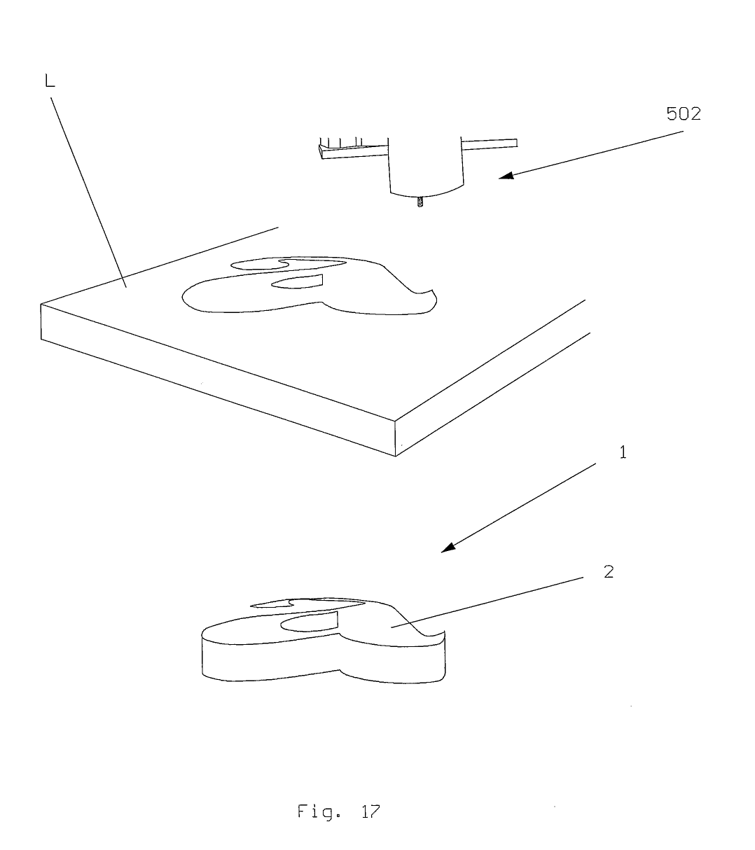

FIGS. 15, 16 and 17 show a corresponding number of working stages for the manufacture of an element for signs of the type shown in FIG. 1.

First of all it is important to point out that corresponding components in different examples of embodiments are indicated by the same reference numbers.

The position indications given in the different examples of embodiment should be transferred to the new position.

The element that is the subject of the invention is particularly suited to be used for making signs, in particular company name and trade name signs.

Obviously, the same element can be used also for making other types of writings, signs and structures suited to display any type of information and/or having a decorative purpose.

A non-limiting example of embodiment of an element for signs that is the subject of the invention is represented in FIGS. 1, 2 and 3, where it is indicated as a whole by 1.

It substantially comprises a main body 2 that, according to the invention, is made from a polymer, more particularly of a thermoplastic or thermosetting resin, preferably comprising polyurethane foam.

More precisely, according to a preferred embodiment of the invention, the material used belongs to the family of polyurethane foams having density is preferably included between 250 Kg/m3 and 490 Kg/m3, and in particular rigid polyurethanes.

This material advantageously makes it possible to obtain an element for signs that is particularly light, resistant to weather agents like wind, water, drops in temperature and capable of keeping its dimensional and mechanical characteristics substantially unchanged over time.

In fact, the mechanical and physical characteristics of this material are particularly advantageous in the making of this type of elements for signs 1 and is lighter than the materials commonly used in the known art for making the same elements 1.

Furthermore, this material is less expensive, less subject to the fluctuations of the international markets and easier to find on the market.

The proposed solution makes it possible to obtain an element 1 in one single piece, lighter and cheaper than the known elements for signs and provided with excellent aesthetical and functional characteristics, which remain unchanged over time independently of environmental conditions.

Furthermore, its lightness makes the installation of the element 1 easier, quicker and safer for the operators in charge with installation.

Advantageous embodiments have been obtained using polyurethanes with density equal to 320 Kg/m3, 450 Kg/m3, 490 Kg/m3 and thicknesses ranging from 2.5 to 10 cm.

Nonetheless, it is clear that other types of plastic materials having characteristics similar to those of the materials specified above can be used to make the main body 2, provided that they are suitable for achieving the objects of the invention. More particularly, always according to the invention, it will be possible to use other types of polyurethane foam or, more generally, other polymers and resins. More precisely, other solutions include the use of polyvinyl chloride foam like extruded PVC or rigid or foam PVC, or extruded, cast or foam polymethylmethacrylate PMMA.

This type of materials also makes it possible to manufacture said element employing an advantageous process, that is also the subject of the invention and that will be described below.

It must also be observed that in the particular, non-limiting example of embodiment represented herein the main body 2 is solid and shaped, more particularly it has the shape of a letter of the alphabet, more precisely it reproduces the letter A.

It is clear, however, that this body may have any shape, even particularly complex.

The body 2 also comprises at least one front side 3 suited to be in sight and a rear side 4.

In the example of embodiment proposed herein at least the front surface 3 of the body 2 or parts of said surface, in particular the parts in sight and/or the parts exposed to weather agents, are preferably treated with products such as paints and/or coloured lacquers that advantageously are directly sprayed thereon and are suited to create a waterproof layer resistant to the aggression of mildew or batteries and/or to make the element particularly attractive.

These products, as already said, are sprayed directly on the material, avoiding the application of primers, with consequent money savings and reduced painting times.

It is clear that further processing and/or decorations and/or coverings and/or treatments can be carried out on the surface of the body 2 or on portions of said surface.

Another non-limiting example of embodiment of an element for signs that is the subject of the invention is represented in FIGS. 3, 4 and 5, where it is indicated as a whole by 100.

It differs from the previous embodiment due to the fact that the element has the shape of an N and that the main body 2a has on its rear side 3 at least one groove 6 suited to house the lighting means 7 comprising luminous elements 8 that are visible in particular in FIG. 4.

This allows the light emitted by the luminous elements 8 to exit from the opening defined by the groove 6 to lighten the back of the element 100 when this is fixed, for example, to a wall W as shown in FIG. 5.

More particularly, the light emitted by the luminous elements 8 exits from the back of the element 100 and strikes the wall W to which said element is applied, creating a diffuse and much appreciated halo effect.

As to the luminous elements 8, they preferably comprise LEDs.

It is clear, however, that alternatively it is possible to use other types of luminous elements 8, like for example fluorescent tubes, neon tubes, incandescent lamps or other equivalent devices.

It should be observed in particular that the use of leds advantageously makes it possible to obtain an element 100 whose lighting system is highly durable and efficient, and offers performance levels that don't worsen over time, very low consumptions, high light efficiency as well as reduced weight and size, and requires minimum maintenance.

In fact, it is important to observe that these lamps with leds have very small dimensions compared to other types of lamps and therefore make it possible to obtain elements 100 that are small as well as quick and easy to install, while at the same time involving reduced consumptions.

Another non-limiting example of embodiment of an element for signs that is the subject of the invention is represented in Figures from 6 to 9, where it is indicated as a whole by 101.

It differs from the previous embodiment due to the fact that the element 101 reproduces once again the letter A and that the main body 2b has on its front side 3 at least one through opening in sight, covered by a sheet of transparent material 12 having any shape, suited to allow the light emitted by the luminous elements 8, visible in particular in FIG. 8, to exit also from these openings and lighten said element 101.

Also this solution advantageously makes it possible to obtain an element whose appearance is much appreciated and that, when applied to a wall W, as shown in particular in the example of FIG. 9, is illuminated both at the front and at the back.

Another non-limiting example of embodiment of an element for signs that is the subject of the invention is represented in FIGS. 10, 11 and 12, where it is indicated as a whole by 102.

It differs from the previous one due to the fact that the element 102 is closed also on the rear side 4.

More precisely, in this embodiment the main body comprises two parts, a front part 20c, and a rear part 21c, shown in particular in FIG. 11, which are overlapped and joined by means of screws or bonding agents in such a way as to form the main body of the element 102.

The front part 20c houses a transparent sheet 12 while the rear part is provided with a groove 6 where the leds 8 are housed, as shown in detail in FIG. 12.

The lighting means are thus arranged inside the main body of the element 102 and the light emitted by them can exit from the body and lighten the element 102 through the sheet 12.

In other embodiments of the invention the number of parts can be higher, for example three.

In this case the main body of the element 102 comprises, in addition to the two parts mentioned above, a further intermediate part, suited to space the other two, in such a way as to define at least one seat suited to house the lighting means 7.

In this case, therefore, the rear part may also not be provided with the groove 6 visible in FIG. 12 and necessary to house the lighting means 7.

It is clear that in other embodiments the main body of the element 102 may comprise a different number of parts cooperating with one another to make the element for signs.

An example of embodiment of a sign that is also the subject of the invention is shown in FIG. 13, where it is indicated as a whole by the numeral 200.

The sign is shown applied to the wall W of a building and comprises a frame that is not visible and is provided with means for fastening to the wall W, more elements for signs of the type described above being fixed to said frame, and wherein each of said elements has, in the example shown, a different shape, and more precisely the shape of a letter of the alphabet in such a way as to form a word.

It is clear that any of the elements for signs described above with direct or indirect light can be applied to the frame.

According to a further non-limiting embodiment of the invention not represented herein, the sign has no frame and the elements are connected to one another, for example by joints, to form the sign itself, as well as being provided with the above mentioned fastening means for anchorage to the wall W.

According to a further non-limiting embodiment of the invention not represented herein, the sign consists of a single main body made from the materials described above and having the desired shape consisting, for example, of several letters or symbols.

As to the process for making an element for signs, which is also the subject of the invention, it comprises the following steps: determining the desired shape of the sign element and cutting out the main body or its parts from a sheet made of a polymer of the type described above, preferably using automatic machine tools.

The process proposed may also comprise a further operation intended to make any grooves suited to house, for example, the above mentioned lighting means, always preferably using automatic machine tools.

FIG. 14 shows an example of a system, indicated as a whole by 500, suited to implement the process described above.

It comprises a machine tool 501 provided with means 502 for cutting out said main body or its parts, controlled by a control unit 503 through which the operator sets in advance the shape and the characteristics of the desired element and/or of its main body and/or of its parts.

In the preferred non-limiting embodiment of the invention represented herein the machine tool is a machine for removing material, and more precisely a milling machine.

This machine, in fact, makes it possible to process a sheet made from a polymer of the type described, in such a way as to cut out the sign element in the desired shape, as well as to make any through openings and/or grooves suited to receive, for example, the lighting means or the sheets in transparent material.

More precisely, the milling machine comprises a frame 505 associated with said means for cutting out said element indicated as a whole by 502, arranged on top of a conveyor unit 504 on which there is a sheet L of the type mentioned above. The conveyor unit 504, which may or not belong to the system 500, is generally constituted by a conveyor belt that moves the sheet L along a rectilinear advance direction indicated with arrow 506 in the figure, in order to carry it towards the operating area of the above mentioned means 502.

The means 502 are associated with the frame 505 through moving means indicated as a whole by 507.

Said moving means 507 are suited to move the means 502 along three axes 508a, 508b and 508c at right angles to one another, in order to lower/raise the means 502 and move them along a horizontal plane in such a way as to be able to cut the sheet L and obtain a body substantially having any shape and being provided with grooves, if any. More particularly, the moving means 507 comprise guide means provided with two moving rails, not visible, that define the above mentioned axes 508a, 508b and 508c, along which the tool carrier 502 moves.

As already explained, the movements of the various parts of the system 500 are to controlled by a control unit 503, provided with operator interface means that allow the operating parameters of the system 500 and in particular of the machine 501 to be controlled and set as previously described.

In the particular embodiment of the invention represented herein, the control unit 503 comprises a computer 503a and the interface means comprise a keyboard 503b, a mouse 503c and a monitor 503d with which the operator can set the above mentioned processing parameters of the machine, like for example the type of material, the processing speed, the rotation speed of the tool, the diameter of the tool, ecc. as well as the desired shape of the element and/or sign using, for example, CAD or numerical control systems.

In the preferred embodiment of the invention represented, the control unit 503 also comprises storage means including, for example, a disc unit on which the operator can store the shape of an element or of a sign carried out, with the corresponding operating parameters of the system and of the machine, so that he/she can recall them, when desired, to make the same sign element.

The above clearly shows that, advantageously, the process proposed and the system described allow also an unskilled operator to make complex elements for signs having any shape and dimensions, by simply using the control unit.

It will be sufficient, in fact, to set the shape of the desired element using the above mentioned processing unit, if necessary indicating the depth and position of any grooves and/or through openings, or to recall the information regarding the processing parameters and the shapes of elements made in the past that have been stored in the above mentioned storage means.

This advantageously makes it possible to manufacture elements for signs having identical and repetitive characteristics, and to determine their production costs.

The process and the system proposed can clearly be used to make all the types of elements for signs that are also the subject of the invention, as well as to make a sign of the type described above.

In practice the operator, using a special program, for example a CAD or similar program installed in the processing unit 503, defines the profile desired for the main body 2 of the sign element through the interface means with which the processing unit 503 itself is provided.

Analogously, the operator also defines any grooves and/or openings to be created on the main body or its parts.

Successively the operator, once he has defined the shape of the sign element and of its parts, starts the processing.

Thus, the processing unit provides for starting the conveyor unit that places the sheet L which was previously placed on it in line with the means 502 of the milling machine 501.

Then the processing unit activates the milling machine 501, that is, the means 502, thus setting the rotary tool or cutter rotating or moving it along the three axes 508a, 508b and 508c mentioned above, so that the tool covers a closed trajectory that reproduces the set perimeter of the main body of the sign element, until causing the detachment of the sheet L, as shown by way of example in FIGS. 15, 16 and 17.

Each of said figures, in fact, shows a processing stage in the making of the main body 2 of the element for signs of the type previously indicated by number 1, starting from a sheet L and using the milling machine 501.

It should also be noted that if the operator intends to make grooves or through openings, these are preferably created before detaching the main body from the sheet itself with the means 502.

Said means 502, in fact, move along the three axes mentioned above and in particular along the vertical axis 508c. This advantageously makes it possible to check the depth to which the tool cuts into the main body in order to obtain grooves/seats of any shape and depth.

It is clear that in other embodiments the system may comprise specific means suited to make said grooves/seats, separate from the means suited to cut out the shape of the main body.

It should also be observed that in order to keep the sheet L still during processing the system may comprise means for locking the sheet, including, for example, a suction system. This suction system is suited to generate a vacuum on the surface where the sheet L is positioned during processing, and said vacuum holds the sheet in position.

Successively the operator takes the main body at the exit of the system and proceeds to carry out the assembly of other parts, like for example the lighting means or the transparent sheets, as well as any finishing operations, like for example painting.

It should also be noted that in other embodiments the system may also comprise different machines that in any case must be such as to allow the desired element to be obtained starting from the above mentioned sheet, like for example a cutting machine.

The above clearly shows that the solution proposed allows the said objects to be achieved and offers the advantages described.

More particularly, the proposed solution makes it possible to manufacture elements for signs having the desired shapes and dimensions, repetitive over time in a substantially automatic manner, with no need for the direct intervention of an expert operator and independently of his/her manual skills, so that the operator does not intervene directly and manually during the manufacture of the element.

The above clearly shows that the element and/or sign carried out according to the invention make it possible to obtain elements and signs comprising bodies in one single piece that can be manufactured with no need for any welding and/or tinning operation, differently from those carried out according to the known art, thus eliminating the drawbacks previously described.

Even though the invention has been described making reference to the attached drawings, upon implementation changes can be made that shall all be considered protected by the present patent, provided that they are within the scope of the inventive concept expressed in the following claims.

It is also important to remember that when the details mentioned in the claims below are followed by references, these must be understood as meant to improve the comprehensibility of the claim in question and not as a limit to the interpretation of the same.

1-43. (canceled)

44. Element for signs comprising a main body, said main body being made from a polymer comprising a resin; characterized in that said resin comprises a polyurethane foam.

45. Element according to claim 44, characterized in that said polyurethane foam is of the rigid type.

46. Element according to claim 44, characterized in that said polyurethane foam has a density preferably included between 250 Kg/m3 and 490 Kg/m3.

47. Element according to claim 44, characterized in that said polyurethane foam has a density substantially equal to 320 Kg/m3.

48. Element according to claim 44, characterized in that said polyurethane foam has a density substantially equal to 450 Kg/m3.

49. Element according to claim 44, characterized in that said polyurethane foam has a density substantially equal to 490 Kg/m3.

50. Element according to claim 44, characterized in that said polyurethane foam has a thickness ranging from 2.5 to 10 cm.

51. Element according to claim 44, characterized in that said main body has on one side at least one groove suited to house lighting means.

52. Element according to claim 51, characterized in that said at least one groove is made on a rear side of said main body.

53. Element according to claim 51, characterized in that said lighting means comprise at least one led and/or at least one fluorescent tube, and/or at least one incandescent lamp.

54. Element according to claim 51, characterized in that said main body has on its front visible side at least one through opening covered by a sheet of transparent material.

55. Element according to claim 51, characterized in that said element is closed also on its rear side.

56. Element according to claim 44, characterized in that said main body comprises at least two parts cooperating with each other to form said main body.

57. Element according to claim 44, characterized in that said main body is made in a single piece.

58. Sign comprising at least one sign element, characterized in that said sign element is manufactured according to claim 44.

59. Process for making an element for signs, said process comprising the following operations:
defining the shape desired for the sign element;
cutting out the main body of said sign element or its parts from a sheet made of a polymer comprising a resin, preferably using automatic machine tools; characterized in that said resin comprises a polyurethane foam; and
making one or more grooves suited to house lighting means, preferably using automatic machine tools.

60. Process according to claim 59, characterized in that said polyurethane foam is of the rigid type.

61. Process according to claim 59, characterized in that said polyurethane has a density preferably included between 250 Kg/m3 and 490 Kg/m3.

62. Process according to claim 59, characterized in that said polyurethane has a density substantially equal to 320 Kg/m3.

63. Process according to claim 59, characterized in that said polyurethane has a density substantially equal to 450 Kg/m3.

64. Process according to claim 59, characterized in that said polyurethane has a density substantially equal to 490 Kg/m3.

65. Process according to claim 59, characterized in that said sheet has a thickness included between 2.5 and 10 cm.

66. Process according to claim 59, characterized in that it comprises also the following operation:

67. Process according to claim 64, characterized in that said machine tool is a milling machine.
